(19) United States
(12) Patent Application Publication
(10) Pub. No.: US 2007/0282514 A1
(43) Pub. Date: Dec. 6, 2007

(54) Method And System For Remotely Controlling Speed Limitation For A Motor Vehicle

(75) Inventors: Jean Paul Jarrix, Asnieres (FR); Jean Antoine Petit, Les Hogues (FR); Laurent Salesse, Les Molieres (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT s.a.s, Boulogne Billancourt (FR)

(21) Appl. No.: 10/589,513

(22) PCT Filed: Feb. 10, 2005
(86) PCT No.: PCT/FR05/50084

§ 371 Date: Jul. 12, 2007

(30) Foreign Application Priority Data
Feb. 17, 2004 (FR) 0401575

(51) Int. Cl. G05D 13/00

(52) U.S. Cl. 701/96

(57) ABSTRACT

A method for remotely controlling speed limitation of a vehicle provided with a telemetric device and a controller automatically controlling the engine speed and distance. The method, after activating, selects a set speed and, in the absence of a vehicle or in the presence of a faster vehicle on the same traffic lane, limits the engine torque by the driver's action applied to an accelerator pedal when the speed is lower than the set speed and by automatic control when the set speed is attained or exceeded such that it is deactivatable. In the presence of a slower vehicle running ahead of the equipped vehicle, the method automatically reduces the speed and maintains a follow-up time between two vehicles such that it is constant and adjustable by the driver and enables the driver to reduce the speed determined by the method without deactivating the method.

The present invention relates to a method of limitation of speed for a motor vehicle with distance control with respect to the vehicle in front in the same traffic lane. This system helps the driver to comply with a speed limitation and/or a following time behind the vehicle in front, which time is defined by the ratio of the distance separating the two vehicles to the speed of the vehicle equipped with the system. It also relates to a system for implementing this method.

There currently exist systems for limiting the speed of a vehicle to a value fixed by the driver, intended to prevent the driver from exceeding a preset limit value which he has chosen, save through a deliberate special maneuver.

Such a speed limiting system comprises in particular an accelerator pedal, or any engine power control member maneuverable by the driver, making it possible to accelerate the vehicle. It moreover comprises means giving the pedal a first active travel and then a second dead travel up to a hard point, which is manifested as a fixed point of the stroke of the pedal, irrespective of the limit speed chosen.

The information regarding the position of the accelerator pedal is transformed into a signal of request of acceleration on the part of the driver that an electronic computer will compare with an acceleration request signal due to the speed regulation and calculated as a function of the difference between the actual speed of the vehicle and the preset speed. Comparison between these two acceleration request signals, due to speed regulation on the one hand and due to the pedal on the other hand, makes it possible to determine a vehicle acceleration control signal.

An exemplary embodiment of a speed limiter is described in the patent application published as No. FR 2 755 650, in the name of RENAULT. In this example, the pedal comprises a dead travel between a first active travel and a hard point, and this hard point manifests itself as a fixed point of the stroke of the pedal, irrespective of the limit speed chosen.

The speed limiter limits the torque of the engine of the vehicle, so as to prevent the exceeding of a limit speed fixed by the driver, without action on the braking system. As long as this limit value is not reached, the relation which rereads the position of the accelerator pedal to the engine torque is identical to that which exists when the limiter is inactive, that is to say that depressing the pedal increases the acceleration and that lifting the foot causes a deceleration, but when the preset limit speed is reached, the engine torque is limited to a value which does not allow the vehicle to exceed this speed. Any further pressing of the pedal beyond this reference position has no effect on the torque value and hence on the speed of the vehicle, and corresponds to a dead travel or zone of the pedal.

On the other hand, any relaxation of the accelerator pedal short of this reference position, fixing the preset speed of the vehicle, permits a deceleration of the vehicle since the relation between the engine torque and the position of the pedal is again valid.

When the vehicle equipped with the speed limiter is approaching a vehicle that is slower than it, in order to reduce its speed, the driver will have to act on the accelerator pedal by lifting his foot or else on the brake pedal by depressing it.

On the other hand there exist speed regulator systems with distance control—Adaptive Cruise Control—ACC, which control the power of the engine and the brakes of the vehicle with the aim of:
regulating the speed of the equipped vehicle to a constant value without intervention of the driver on the accelerator pedal;
adjusting the speed of the vehicle to a value equal to that of the vehicle in front, traveling more slowly in the same traffic lane;
maintaining a constant following time with the vehicle in front with a lower speed, in the same traffic lane.

To reduce the acceleration determined automatically by the system, the driver must press the brake pedal or else act on a button placed on the steering wheel or on the dashboard, these two actions having the effect of deactivating the speed regulation system with distance control. The acceleration may also be reduced by action of the driver on the preset speed member, not always well suited to all types of situations. In particular, certain complex road situations are poorly managed by the telemetry carried on board the vehicle, possibly causing uncomfortable re-accelerations of the vehicle due to momentary loss of detection of the vehicles in the lane, on bends for example.

The aim of the invention is to alleviate the drawbacks of these two types of systems described above, that is to say having to brake in speed limitation, in the approach phase, on the one hand, and deactivate the speed regulation in order to reduce the acceleration on the other hand.

To do this, a first subject of the invention is a method of speed limitation with distance control for a motor vehicle equipped with telemetry means intended to estimate the distance and the speed of the vehicles traveling in the same traffic lane as the vehicle, and means of slaving of the operation of the engine speed-wise and distance-wise, characterized in that it carries out the following steps:
a) activation of the method;
b) choice of a speed preset;
c) verification of the absence of a slower target vehicle in the same traffic lane, and if so:
e) limitation of the engine torque by action of the driver on the acceleration pedal as long as the vehicle speed is below the preset speed and by automatic control when the preset speed is reached or exceeded, with possibility of deactivation of the method;
d) verification of the presence of a slower target vehicle in front of the equipped vehicle in the same traffic lane, and if so:
f) automatic reduction of the speed and maintaining of a constant following time between the two vehicles, which can be adjusted by the driver;
g) reduction, permitted to the driver, of the speed determined by the method, by lifting of the foot on the accelerator pedal or pressing the brake without deactivating the method of speed limitation;
h) verification of the speed of the target vehicle, and in case of increase beyond the preset speed, possibility of acceleration for the driver of the equipped vehicle up to the speed preset or distance preset if the target vehicle is caught up with again.

A second subject of the invention is a system for implementing said method of limitation of speed with distance control for a motor vehicle, comprising first telemetry means intended to estimate the distance and the speed of the vehicles traveling in the same traffic lane as the equipped vehicle, and second means of slaving of the operation of the engine speed-wise and distance-wise, receiving as input a speed preset and a following time preset and delivering a vehicle acceleration and braking command, characterized in that it comprises moreover:
third means of reconstruction of the braking request of the driver, intended to deliver a signal homogeneous with the braking command delivered by the aforesaid slaving means;
fourth means of reconstruction of the acceleration request of the driver, intended to deliver a signal homogeneous with the acceleration command delivered by the aforesaid slaving means;
fifth means of arbitration between the braking signal requested by the driver and the braking command by calculation of the maximum value between these two braking values;
sixth means of arbitration between the acceleration signal requested by the driver and the acceleration command by calculation of the minimum value between these two acceleration values;
seventh means of arbitration between the control of the braking and that of the acceleration by priority choice of braking over acceleration, delivering control signals to the braking member of the vehicle and to the engine.

Other characteristics and advantages of the invention will become apparent on reading the description illustrated by the following figures:

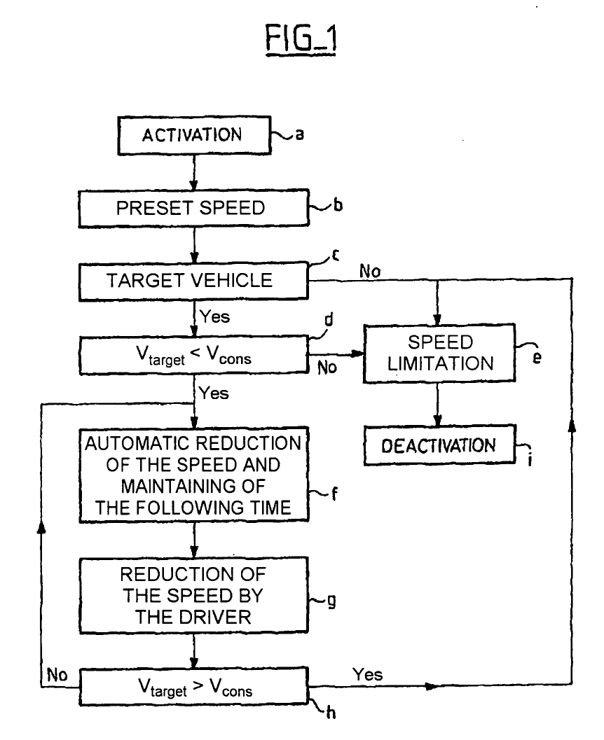

FIG. 1: a method of speed limitation with distance control of a vehicle according to the invention;

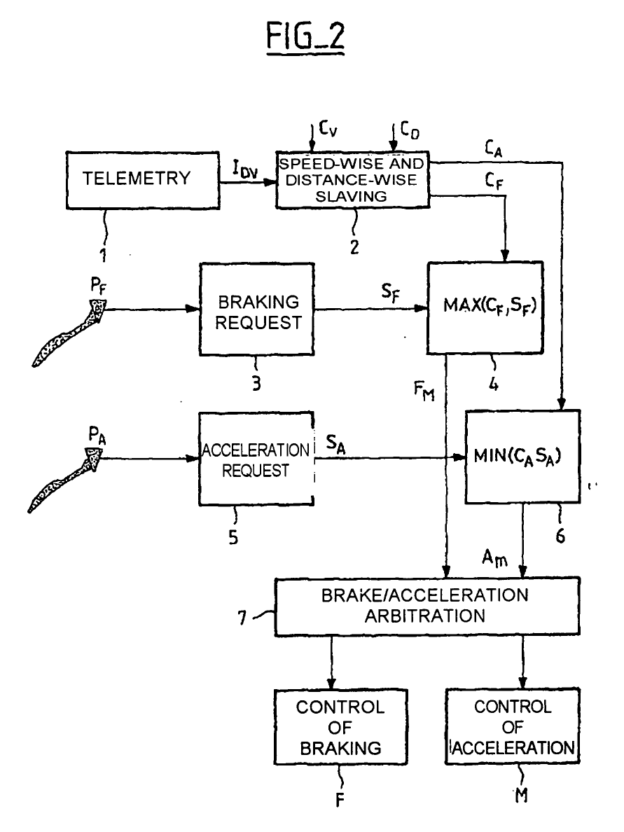

FIG. 2: an example of a system for implementing the method of speed limitation with distance control according to the invention.

The invention is intended for limiting the speed of the vehicle equipped with the system while yet controlling its distance with respect to the vehicle in front in the same traffic lane, while the driver keeps his foot on the accelerator pedal or presses the brake pedal without deactivating the system.

When the driver has triggered the activation of the method, in step a), and fixed a speed preset in step b), if the absence of any slower target vehicle in the traffic lane is verified, that is to say either in the absence of any vehicle noted in step c), or in the presence of a faster vehicle, noted in step d), the method carries out the conventional speed limitation function, (step e), which limits the engine torque so as not to exceed the preset speed that the driver himself has fixed. For vehicle speed values below the preset, the position of the accelerator pedal imposed by the driver corresponds to a given acceleration, and for speed values above the preset, the system automatically limits the engine torque. To this limit value of torque there corresponds a reference position of the accelerator pedal, beyond which any further depression has no effect.

In the presence of a slower vehicle in front of the equipped vehicle traveling at the preset speed and called the target, noted in step d), the method automatically reduces the speed of the equipped vehicle without the driver having to lift his foot from the accelerator pedal or resume control of the vehicle, and maintains a following time between these two vehicles which is constant and the value of which can be adjusted by the driver (step f).

However, at any moment the driver can himself reduce this speed determined automatically by the system, by acting on the accelerator pedal by lifting his foot, or by depressing the brake pedal, without causing the deactivation of the system (step g).

If the distance between the two vehicles increases, that is to say if the speed of the target vehicle of the lane detected in step h) increases, the driver can again re-accelerate until the speed preset or distance preset is reached if the vehicle followed is caught up with again.

To carry out these steps as a function of the presence or of the absence, on the same traffic lane, of any vehicle slower than the equipped vehicle, the vehicle is equipped with an implementation system which comprises the following various elements.

To begin with, it is equipped with first means of estimation of the distance and of speed of the vehicles traveling in the same traffic lane, such as a telemeter, a radar or a lidar for example. The telemetry means 1 deliver information I_{DV} regarding the distance and the speed of the vehicles traveling in the same lane as the vehicle, ahead of it. This information is dispatched to second means 2 of slaving of the operation of the engine speed-wise and distance-wise, which additionally receive as input a speed preset Cᵥ and a distance preset C_{D}. These slaving means deliver an acceleration command C_{A} or braking command C_{F} to the relevant members of the vehicle, either the engine M or the braking system F.

The system according to the invention moreover comprises third means 3 of reconstruction of the braking request of the driver, this being manifested as a pressing force on the brake pedal. This request must be homogeneous with the braking request delivered by the slaving means 2, which may be a pressure in the braking circuit, a deceleration torque or a flow rate of fuel for example. The means 3 transform the pressing force P_{F} on the brake pedal into a quantity homogeneous with the braking command and deliver a signal S_{F} homogeneous with the braking command C_{F}, these two signals ending up as input to fourth means 4 of arbitrating between them. The means 4 arbitrate between these two braking requests by determining the maximum F_{M} between these two values S_{F} and C_{F}, so that the stronger request is taken into account, be it the automatic command or the request of the driver, to control the braking.

Concerning the driver acceleration request which is manifested as a pressing force P_{A} on the acceleration pedal, it must be rendered homogeneous with the acceleration command C_{A} delivered by the means 2 of slaving of the engine so as to be compared with it. To do this fifth means 5 of reconstruction of this request transform it into a quantity S_{A} homogeneous with the acceleration command C_{A}, which may for example be a torque request. The two homogeneous acceleration signals S_{A} and C_{A} end up as input to sixth means 6 of arbitrating between them, by determining the minimum between these two values so that the weaker request Aₘ is taken into account to control the acceleration of the vehicle.

The system finally comprises seventh means 7 of arbitrating between the control of the braking F and the control of the acceleration of the vehicle M, by choosing in the nominal mode to always favor braking over acceleration. Thus, if the driver or the speed limitation system simultaneously requests braking and acceleration, it is the deceleration preset which will be dispatched to the braking member.

If the system has in addition a device offering the driver the possibility of resuming control, by way of a device such as a mechanical hard point at the extremity of the travel of the accelerator pedal, otherwise known as a ‘kick down’ for example, and should the driver actuate this device deliberately, priority is then given to the braking or acceleration requests of the driver over the requests of the speed limitation system.

1-3. (canceled)

4: A method of speed limitation with distance control for a motor vehicle equipped with telemetry means to estimate a distance and a speed of vehicles traveling in a same traffic lane as the vehicle, and means of slaving operation of the engine speed-wise and distance-wise, the method comprising:
a) activation of the method;
b) choice of a speed preset;
c) verification of absence of a slower target vehicle in the same traffic lane, and if so:
e) limitation of engine torque by action of a driver on an acceleration pedal as long as the vehicle speed is below the preset speed and by automatic control when the preset speed is reached or exceeded, with possibility of deactivation of the method;
d) verification of presence of a slower target vehicle in front of the equipped vehicle in the same traffic lane, and if so:
f) automatic reduction of speed and maintaining of a constant following time between the two vehicles, which can be adjusted by the driver;
g) reduction, permitted to the driver, of the speed determined by the method, by lifting the driver's foot on the accelerator pedal or pressing the brake without deactivating the method of speed limitation;
h) verification of the speed of the target vehicle, and in case of increase beyond the preset speed, possibility of acceleration for the driver of the equipped vehicle up to the speed preset or distance preset if the target vehicle is caught up with again.

5: A system for implementing a method of limitation of speed with distance control for a motor vehicle, comprising:
first telemetry means to estimate a distance and a speed of vehicles traveling in a same traffic lane as an equipped vehicle;
second means of slaving operation of the engine speed-wise and distance-wise, receiving as an input a speed preset and a following time preset and delivering a vehicle acceleration and braking command;
third means of reconstruction of a braking request of a driver, to deliver a signal homogeneous with a braking command delivered by the second means;
fourth means of reconstruction of an acceleration request of the driver, to deliver a signal homogeneous with an acceleration command delivered by the second means;
fifth means of arbitration between a braking signal requested by the driver and a braking command by calculation of a maximum value between these two braking values;
sixth means of arbitration between an acceleration signal requested by the driver and the acceleration command by calculation of the minimum value between these two acceleration values; and
seventh means of arbitration between control of the braking and that of the acceleration by priority choice of braking over acceleration, delivering control signals to a braking member of the vehicle and to the engine.

6: The system as claimed in claim 5, further comprising a device for resumption of control by the driver, by mechanical hard point at an extremity of travel of the accelerator pedal, and the seventh means of arbitration giving priority to the braking or acceleration requests of the driver over the requests of the speed limitation speed when the device is activated by the driver.
